(19) United States
(12) Patent Application Publication
(10) Pub. No.: US 2026/0166508 A1
(43) Pub. Date: Jun. 18, 2026

(54) PROCESS FOR PRODUCING ACTIVATED CARBON, ACTIVATED CARBON AND USE THEREOF

(71) Applicant: FORNAX HOLDING GMBH, Hannover (DE)

(72) Inventor: Raik SCHÖNFELD, Hannover (DE)

(21) Appl. No.: 19/129,490

(22) PCT Filed: Nov. 24, 2023
(86) PCT No.: PCT/EP2023/082921

§ 371 Date: May 13, 2025

(30) Foreign Application Priority Data
Nov. 24, 2022 (DE) 10 2022 131 126.0

(51) Int. Cl. B01J 8/18; B01D 53/06; B01J 8/00; B01J 20/28; B01J 20/30

(52) U.S. Cl. CPC B01J 8/1827; B01D 53/06; B01J 8/009; B01J 20/28004; B01J 20/28016; B01J 20/28019; B01J 20/28083; B01J 20/3078; B01D 2253/102

(57) ABSTRACT

The present invention relates, in a first aspect, to a process for producing activated carbon, said process being characterized in that the carbonized carbon source is activated in the reaction chamber in a fluidized bed. Furthermore, the present invention is directed to correspondingly obtainable activated carbon and the use thereof, especially as adsorbent in various applications.

The present invention relates, in a first aspect, to a process for producing activated carbon, this process being characterized in that the carbonized carbon source is activated in the reaction chamber in a fluidized bed. Furthermore, the present invention is directed to correspondingly obtainable activated carbon and the use thereof, especially as an adsorbent in various applications.

### PRIOR ART

Activated carbon has a diverse range of uses in industry, especially as adsorption materials for fluids which occur in liquids or gases, such as air. It typically comprises porous, fine-grained carbons with a high internal surface area, which consequently have corresponding adsorption properties. In addition to its use as an adsorbent, examples being in chemistry, medicine, ventilation and air-conditioning, and also for the processing of drinking water and wastewater, activated carbon is employed in medical sectors, and also as support materials for active substances, such as biological or chemical catalysts.

With activated carbon, pore size and pore size distribution are divided fundamentally into different size orders, these being submicropores with pore sizes of <0.4 nm, micropores in the range from 0.1 to 2 nm, mesopores in the range from 2 to 50 nm, and macropores with sizes of more than 50 nm.

The micropores and mesopores in particular are key to the adsorption properties of the activated carbon. They represent the corresponding access pathways for the gases and liquids into the particulate open-pored activated carbon. Accordingly, they substantially determine the transport events and the diffusion events in the inner regions of the particulate activated carbon.

The adsorption property can be significantly boosted by appropriate formation and proportions of mesopores and optionally macropores.

In addition to the acquisition of the activated carbon from plant, animal or mineral starting products, it can also be acquired from petrochemical substances, including plastics. As well as a first step, production typically involves performing a carbonization with subsequent activation of the carbonaceous starting materials.

In carbonization, generally speaking, the carbonaceous starting material is transformed into carbon. The resultant activated carbon at this point already has its key mechanical properties, particularly the base porosity, strength, etc.

The activation that follows the carbonization causes the carbon formed on carbonization to be partially broken down and burned off. Further structural alterations are achieved as a result, including alterations to the pore count and pore size. This activation may be tailored so as to increase the porosity. The activation here is typically an oxidizing process, in which the carbon is transformed into carbon monoxide or dioxide. The activation takes place in general under selective or controlled-typically oxidizing-conditions.

Activated carbon may be in different forms according to application. The particulate activated carbon may frequently be in a granular form and also, depending on application, a spherical form. Spherical, polymer-based activated carbon in particular is found to be particularly free-flowing, is extremely abrasion-resistant, and in this context is particularly hard, so giving rise to particular fields of use.

The production of spherical activated carbon in particular necessitates costly and inconvenient processes, in order, for example, to produce corresponding spherical activated carbon from petrochemical starting materials. DE 20 2016 100 320 U1 describes activated carbon, especially particulate activated carbon, having defined porosity properties. In that case, for example, polymers are used as carbonaceous starting materials. There they are sulfonated in a specific way to improve and adjust the porosity, especially the meso- and macroporosity, in order to achieve defined porosities while retaining advantageous mechanical properties, such as stability and robustness.

A special part is played by the porosity and the pore size distribution, especially in relation to the particular applications of spherical activated carbon. To achieve specific adsorption properties, or high adsorption kinetics and adsorption capacities, corresponding mesopores, but also macropores, play an important part. In this way, effective diffusion into the adsorption pore space of the spherical activated carbon is achieved, with maintenance of excellent adsorption properties, particularly with high mesoporosity. Correspondingly, as described therein, the activated carbon is particularly suitable for producing defined adsorption filter materials, such as molecular filter laminates to counter nuclear, chemical and/or biological toxins or pollutants (NBC protection), for the adsorption of toxicants, pollutants, odors, especially from gas streams or air streams, for the purification of gases, especially air, and of liquids, for the medical and/or pharmaceutical sector, for the sorptive storage of gases or liquids, and the like, for example. They also play an important role in the wastewater processing sector.

The spherical activated carbons described therein are lauded for corresponding suitable porosity and hence high adsorption capacity, while retaining the mechanical stability. Processes for producing this activated carbon are described. A disadvantage of the processes described therein, however, is the costly and inconvenient activation. Activation takes place in at least semicontinuous processes within a rotary kiln at high temperature with a long residence time, causing this process to be cost-intensive and time-consuming.

Against this background, it is an object of the present invention to provide improved processes for producing activated carbon, especially spherical activated carbon, with high adsorption capacity and retention of mechanical integrity. These processes are notable for increased cost efficiency and shortening of the production times. The typically spherical activated carbon thus produced exhibits a corresponding desired property of porosity and integrity and is suitable in particular as an adsorbent in the context of filters or filter materials, such as the abovementioned molecular filter laminates.

### BRIEF DESCRIPTION OF THE INVENTION

In a first aspect, a process for producing activated carbon is provided, this process comprising the steps of
a) providing a carbonized carbon source in a reaction chamber;
b) feeding a fuel gas and a combustion gas into a combustion chamber and burning the two components, to give a process gas;
c) fluidizing the carbonized carbon source in the reaction chamber in a fluidized bed;
d) heating the fluidized carbon source;
e) introducing the process gas of step b) into the fluidized bed, and
f) activating the carbonized carbon source in the fluidized bed of the reaction chamber, to give the activated carbon.

Additionally described are activated carbon obtainable accordingly and the use thereof as an adsorbent, adsorption filter and filter material, including in particular with air and gas filters, protective equipment and protective articles, and also in (waste) water processing.

### BRIEF DESCRIPTION OF THE FIGURES

FIG. 1 shows a process-technological plant for carrying out the process of the invention.

### DESCRIPTION OF THE INVENTION

The invention is directed to a process for producing activated carbon, comprising the steps of:
a) providing a carbonized carbon source in a reaction chamber;
b) feeding a fuel gas and a combustion gas into a combustion chamber and burning them, to give a process gas;
c) fluidizing the carbonized carbon source in the reaction chamber in a fluidized bed;
d) heating the fluidized carbon source;
e) introducing the process gas of step b) into the fluidized bed, and
f) activating the carbonized carbon source in the fluidized bed of the reaction chamber, to give the activated carbon.

The recitation of the process steps here does not constitute a fixed sequence. For example, the providing of the carbonized carbon source in a reaction chamber may be provided before, during or after the providing, after the acquisition of the process gas.

The process of the invention allows a predefined quality of the activated carbon to be obtained. This relates in particular to the pore type and the proportions thereof by volume. It can be obtained in a desired manner (predefined) through corresponding reaction conditions.

A “carbon source” presently is any substance which comprises carbon—typically, organic starting materials. These carbon sources have any particle morphology—in one preferred embodiment, they are granular, especially spherical.

The process allows a cost-efficient production process which is also shortened by comparison with existing processes, while giving, in particular, spherical activated carbon having desired micropores, mesopores and/or macropores and the specific proportions thereof by volume.

As regards the activated carbon or activated carbon particles (also referred to just as activated carbon hereinafter) in accordance with the invention, as such, the parametric data set out thereon are determined using standardized or explicitly stated determination processes or using methods of determination that are familiar per se to the skilled person. In particular, the parametric data concerning the characterization of the porosity and the pore size distribution and other adsorption properties are generally the result in each case of the corresponding nitrogen adsorption isotherms of the respective activated carbon or the products subjected to measurement. Moreover, the pore distribution, including in particular in relation to the content of pores of defined size relative to the overall pore volume, can be determined on the basis of DIN 66135-1.

The applicant surprisingly observed that the use of pulsating fluidized beds or fluidized beds for activating the carbonized carbon source can substantially shorten the treatment time. This allows not only the production of larger quantities of desired activated carbon but also a cost saving in the process.

In one preferred embodiment, the carbon source contains at least one polymer and/or at least one polymer-based compound. The carbon source may comprise at least one or two or more polymer-based compounds. The carbon source may also comprise two or more substances of which at least one contains carbon, preferably a polymer or a polymer-based compound.

The term “polymer-based compound” refers to a substance whose molecular structure is composed primarily or entirely of a large number of units of the same kind connected to one another—for example, many synthetic organic materials which are used as plastics and resins. Polymer-based compounds may consist, for example, of polyethylene and/or polypropylene units. For example, the carbon source may be a styrene-based polymer.

In one embodiment, at least one polymer and/or polymer-based compound is in modified form, being for example oxidized, hydroxylated and/or sulfonated. For example, a sulfonated styrene-divinylbenzene copolymer may be used. The carbon source may contain modified and nonmodified polymers and/or polymer-based compounds. For example, a styrene-divinylbenzene copolymer may be used. For example, the styrene-divinylbenzene copolymer may have been sulfonated beforehand. Further, the carbon source may contain a furfuryl alcohol-based polymer, phenol-based polymer such as phenol-furan resin or phenol-formaldehyde resin and/or furan resin.

In other words, in accordance with the invention it may in particular be the case that the starting material used comprises a starting material based on organic polymers, more particularly based on divinylbenzene-crosslinked polystyrene, preferably based on styrene/divinylbenzene copolymers. In this connection, the content of divinylbenzene in the starting material may be in the range from 0.1% by weight to 25% by weight, more particularly 0.5% by weight to 20% by weight, preferably 1% by weight to 15% by weight, more preferably 2% by weight to 10% by weight, based on the starting material. A material of this kind is especially suitable for use in the context of the process, as in particular it already possesses a defined pore system which is amenable in a particular way to the sulfonation envisaged in accordance with the invention.

In the combustion chamber, in accordance with the invention, fuel gas is ignited together with combustion air (combustion gas) to give an oxygen-free gas, which is referred to below as process gas. Fuel gas used may comprise, for example, hydrogen, methane gas, propane gas and/or butane gas. However, other fuel gases may also be used. In particular, fuel gases having a higher carbon fraction may be used. Mixtures of individual gases may also be employed. The combustion gas may be pure oxygen or contain oxygen. With certain gas combinations, no additional ignition of the gas mixture is needed to initialize the combustion—for example, with hydrogen and oxygen.

In one embodiment, combustion is substoichiometric. This means that less oxygen is fed in than is needed for complete stoichiometric combustion. The combustion gas ratio, lambda, is ≤1. An oxygen-free process gas is obtained as a product of the combustion. An oxygen-free process gas for the purposes of this patent application is a gas which contains no molecular oxygen (O₂). An oxygen-free gas for the purposes of this patent application, conversely, may contain elemental oxygen, such as in CO₂ or CO, for example.

The process gas is passed into the reaction chamber and displaces/mixes with the inert gas present. The process gas consists at least proportionally of the oxygen-free gas obtained from the combustion chamber as a result of the substoichiometric combustion of the fuel gas with the combustion gas. In addition, an inert gas may be added. Examples of possible inert gases are nitrogen, helium and argon. On entry into the fluidized bed, the process gas has a temperature for example of at least 620° C., preferably at least 800° C., more preferably at least 920° C., such as at least 1000° C. or higher.

In one embodiment, the temperature of the process gas is in the range from 620 to 1000° C., such as between 800° C. and 1000° C.

The carbonized carbon source is introduced into the reaction chamber and fluidized by an inert gas. The inert gas used may comprise nitrogen, for example. The carbonized carbon source is preheated by the inert gas or the process gas to the reaction temperature. The reaction temperature may be between 62° and 1000° C., such as between 80° and 1000° C., preferably between 92° and 1000° C. The reaction chamber may additionally be heated from outside by jacket heating, for example, or within the fluidized carbon source by inductive heat generation or by microwaves.

Activation of the carbonized carbon source takes place in the fluidized bed. The temperature for this is at least 650° C. During the activation, two reactions may in principle take place:

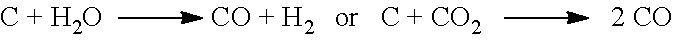

The partial burn off of carbon from the carbonized carbon source produces pores. The ratio of micropores to mesopores may be influenced through the ratio of steam to carbon dioxide. According to IUPAC definition, mesopores are pores having a pore diameter between 2 nm and 50 nm, micropores those with pores<2 nm. The carbon dioxide content may be adjusted by way of carbonaceous gases in the fuel gas, such as methane gas, propane gas and/or butane gas, for example. The water content of the process gas may be adjusted by way of the fraction of hydrogen in the fuel gas. Particularly advantageous ratios, for example, are 80% H₂O to 20% N₂, or 70% H₂O to 30% N₂, additionally 50% H₂O to 30% N₂ to 20% CO₂. The pore distribution may be influenced through the ratio of inert gas to carbon dioxide to water.

On the side of the fluidized bed opposite the infeed of the process gas, the gas is discharged under gentle suction.

The improved heat transfer in a fluidized bed allows the heating of the starting materials, especially the carbon source, for fluidization and to the reaction temperature to be shortened.

In one preferred embodiment, the fluidized bed is a pulsating fluidized bed. In this case, underpressure and overpressure are generated alternately.

A pulsating fluidized bed may be characterized by a non-constant gas volume flow rate, with the possible consequence, for example, of a modulated plug flow in a reaction chamber which is tubular, for example.

Such pulsation may be generated, for example, by rotating valves which are able temporarily to perform at least partial closure and/or opening of the inflow line for the process gas and/or the discharge line for the reaction gas. The pulsating fluidized bed may also be generated by a pulsating combustion.

The volume flow rate of the process gas may be selected such that the pulse volume is able to propagate as a plug flow entirely in the expansion phase of the fluidized bed. For this purpose, the volume flow rate of the process gas at the pressure maximum may be above the fluidization point of the carbon source. At the pressure minimum, the process gas volume flow rate may be slightly below the fluidization point of the carbon source. In this way, a cyclically pulsating fluidized bed is obtained.

The pulsation of the fluidized bed and the resultant pressure switch additionally accelerates the diffusion into and out of the initial- and expanding-pore space in the carbon particle and hence further accelerates the partial oxidation reaction relative to a normal fluidized bed.

In one embodiment, the valve is arranged rotatably on an inflow line or a discharge line, and so can periodically close and open the respective line. The frequency may be adjusted by a control unit. For this purpose, for example, the rotary speed can be measured and/or adjusted. There may also be two or more valves arranged. For example, there may be a respective valve mounted on the inflow line and another on the discharge line. There may also be two or more valves mounted on one line. The valve or the valves may be actuated in tune with one another. An underpressure and/or overpressure in the reaction chamber may be generated by the valve or the actuation of the valves. A cyclically pulsating fluidized bed may be generated by alternate closing and opening of the inflow line and the discharge line. The point at which—because of the valve actuation, for example—the maximum pressure is prevailing in the reactor chamber is called the pressure maximum below. It is preferably located in the region of the overpressure. The point at which—because of the valve actuation, for example—the minimum pressure is prevailing in the reactor chamber is called the pressure minimum below. It may be located in the region of the underpressure.

In one preferred embodiment, the pulsating fluidized bed is generated by a pulsating combustion of the fuel gas. In this case, a fuel gas and combustion air are periodically ignited in a combustion chamber. Here, the temperature, the frequency, the amplitude, and the chemical composition of the combustion product may be adjusted via the gas composition. Particularly advantageous here is a very high frequency of, for example, 40 to 60 s-1. The temperature of the combustion may be, for example, between 65° and 1000° C., preferably at 920 to 1000° C.

In one preferred embodiment, further oxygen-free gases are added to the process gas prior to entry into the fluidized bed. For example, an inert gas may be added to the process gas. Examples of possible inert gases are nitrogen, helium and argon. Carbon dioxide, for example, may be added to the process gas.

In another embodiment, finely atomized water and/or steam are additionally added to the process gas prior to entry into the fluidized bed, in addition to the combustion product of the substoichiometrically burned fuel gas and an inert gas such as nitrogen. Where water is added in the form of a spray mist, it evaporates to steam because of the high temperatures. The steam, for example, may have a temperature between 16° and 1000° C.

The addition of water and/or steam allows the fraction of steam in the process gas to be increased. Moreover, the addition of water and/or steam can be used to adjust—to reduce, for example—the temperature of the process gas.

Through the addition of steam, for example, the rate of the activation may be further increased.

In one embodiment, the temperature in the reaction chamber is at least 650° C., preferably at least 800° C., more preferably at least 920° C., more preferably still at least 1000° C. or more.

The process may further comprise the step of discharging the reaction gas from the reaction chamber, departing as a result of corresponding apparatuses such as fans, etc., for example.

Furthermore, the activated carbon may be discharged by a corresponding outlet. In that case, for example, the activated carbon is blown out with the aid of an inert gas or drawn off under suction by a Venturi effect, in order to enable batchwise production.

In a further aspect, the particulate polymeric organic starting materials are materials which have been sulfonated prior to the carbonization.

Corresponding processes are described for example in DE 20 2016 100 320 U1, which is hereby included.

In one embodiment, the reactor may conform to or be based on the principle of a pulsed tube, pulsation reactor or pulse propulsion mechanism.

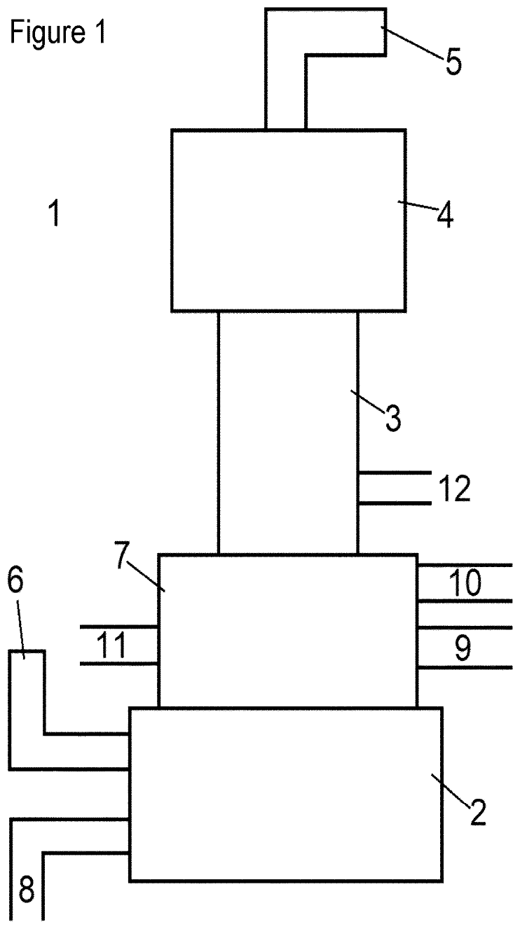

The reactor consists preferably of multiple compartments, such as at least two compartments, a combustion chamber and a reaction chamber. Also conceivable are reactors having more compartments: for example, two or more reaction chambers. A reactor suitable for the present process is, for example, a high-temperature fluidized bed reactor or another tubular reactor with a combustion chamber upstream thereof. The reactor shape may be configured for example as in FIG. 1. However, any other design with at least one combustion chamber and at least one reaction chamber is also conceivable

FIG. 1 here shows a reactor of the invention, also referred to as process-technological plant 1, having a combustion chamber 2. In this combustion chamber, the gases are introduced via the inlets 6 (fuel gas inlet) and 8 (combustion gas inlet) and reacted in the combustion chamber to form the process gas. Following the combustion chamber is a mixing chamber 7, in which firstly the carbonized carbon source, via the feed line 11, and secondly an inert gas, via the feed line 9, are introduced, so that the carbonized carbon source is fluidized.

By way of the mixing chamber 7 or directly into the reaction chamber 3, the process gas is introduced into the reaction chamber 3, wherein the fluidized carbon source is present with the inert gas. Water or steam may optionally be added to the process gas via the feed line 10 prior to entry into the reaction chamber and the fluidized bed therein. In the reaction chamber 3, preferably in a pulsating fluidized bed, the carbonized carbon source is activated to give the activated carbon, preferably in spherical form. The calming chamber reduces the gas velocity in particular in such a way that the carbon source is no longer fluidized, and so prevents the particles of the carbon source emerging from the reaction chamber 3, with reaction gas being taken off via the reaction gas outlet 5.

The reaction chamber is designed such that a fluidized bed can be generated therein—for example, a fluidized bed reactor. Advantageous features include a diameter-to-height ratio for the reaction chamber with which a fluidized bed extends over the entire reactor cross section. In one preferred embodiment, the diameter-to-height ratio of the reaction chamber is dimensioned such that a pulsating fluidized bed pulsates cyclically over the entire reactor cross section.

Furthermore, the reaction chamber has an outlet for the activated carbon particles obtained in the reaction chamber. After the predefined activated carbon quality has been obtained, the reaction is ended, in particular by ceasing the addition of further process gas. In one embodiment, the inert gas is fed in at lower temperature, to end the fluidization of the particles of the carbon source and to obtain the particles with predefined quality.

The activated carbon of the invention may be used for the adsorption of toxicants, pollutants and odors, especially from gas streams or air streams, or for purifying or processing gases, especially air, or liquids, especially water, or for use in adsorption filter materials, more particularly for the production of molecular filter laminates, or as sorption stores for gases or liquids, or in the sector of the food industry, especially for the processing and/or decolorizing of foods, or in the medical or pharmaceutical sector, more particularly as a medicament or medicament ingredient, or for producing protective equipment and/or protective articles of all kinds, especially molecular filter laminates, more particularly for the civil or military sector, such as protection suits, protective gloves, protective footwear, protective socks, protective headwear and the like, and for producing protective coverings of all kinds, preferably all aforementioned protective materials for NBC deployment and/or with a protective function toward radioactive pollutants and/or toxicants, and/or toward biological pollutants and/or toxicants, and/or toward chemical pollutants and/or toxicants, or for producing filters and filter materials of all kinds, especially for removing pollutants, odorants and toxicants of all kinds, preferably for removing radioactive pollutants and/or toxicants and/or biological pollutants and/or toxicants and/or chemical pollutants and/or toxicants, especially from air streams and/or gas streams, such as NBC protective mask filters, odor filters, surface filters, air filters, especially filters for ambient air purification, adsorptive support structures, and filters for the medical sector. The specific properties of the activated carbon produced in accordance with the invention hence make it suitable for a plethora of different technical applications.

The present invention further relates to the use of the activated carbon producible in accordance with the invention in protective equipment and protective articles of all kinds, especially for the civil or military sector, more particularly molecular filter laminates, for protection suits, protective gloves, protective footwear, protective socks, protective headwear and the like, and also protective coverings, preferably all aforementioned protective equipment and/or protective articles for NBC deployment and/or with a protective function toward radioactive pollutants and/or toxicants and/or toward biological pollutants and/or toxicants and/or toward chemical pollutants and/or toxicants, produced using an activated carbon.

Lastly, the present invention also relates to the use of the activated carbon producible in accordance with the invention in filters and filter materials of all kinds, especially for removing pollutants, odorants and toxicants of all kinds, preferably for removing radioactive pollutants and/or toxicants and/or biological pollutants and/or toxicants and/or chemical pollutants and/or toxicants, especially from air streams and/or gas streams, such as in protective mask filters, odor filters, surface filters, air filters, especially filters for ambient air purification, adsorptive support structures, and filters for the medical sector.

### EXAMPLES

### Example 1

Example 1 compares the activation of a carbon source in a rotary kiln heated indirectly by jacket heating, and by pulsating combustion in a pulsating fluidized bed. The carbon source used was 10 kg of an already sulfonated styrene-divinylbenzene copolymer which was carbonized under inert atmosphere at a maximum temperature of 920° C. The carbon source was introduced into the reaction chamber and heated under inert atmosphere to the activation temperature of 957° C. The preheated process gas (N₂:H₂O:CO₂ at 30:70:0) was subsequently passed from the combustion chamber into the reaction chamber.

On attainment of a specific surface area of 1000 m²/g, determined by previously calibrated 1-point BET, activation was ended in each case by interrupting the flow of process gas and cooling the resultant activated carbon to below 180° C. by infeed of an inert gas.

A significantly reduced activation time was required for the pulsating fluidized bed, as is clear from Table 1 below.

The spherical activated carbon particles obtained were analyzed for the total pore volume and the micropore volume. The specific surface area and the total pore volume were ascertained according to DIN ISO 9277:2014 by prior recording of a low-temperature nitrogen sorption isotherm. The micropore volume was determined in each case by the methodology of Dubinin-Radushkevich and also by t-plot.

In addition, density functional theory (DFT) was used to ascertain the pore size distribution. The calculation model used was a DFT kernel for N₂/77 K on a carbon surface with assumption of slit pore geometry (“N₂ at 77 K on carbon (slit pore, QSDFT, equilibrium model”)). The methodology used is part of the kernel stored in the analysis software. The nitrogen sorption isotherms were determined using the AUTOSORB-IQ volumetric sorption instrument from Quantachrome GmbH & Co. KG.

The results of the texture parameters derivable from the nitrogen isotherms are collated in Table 1.

TABLE 1
Texture parameters ascertained for activated carbon produced
by a pulsating fluidized bed and a rotary kiln

| | | Pulsating | |
|---|---|---|---|
| | | fluidized | Rotary |
| Texture parameter | Units | bed | kiln |
| Specific surface area (BET) | m²/g | 1198 | 1181 |
| Total pore volume | cm³/g | 0.696 | 0.504 |
| Micropore volume t-plot | cm³/g | 0.444 | 0.463 |
| Micropore volume DR | cm³/g | 0.499 | 0.455 |
| Activation time | min | 280 | 800 |

It becomes clear that in a comparison between the process of the invention with pulsating fluidized bed and the process with a rotary kiln, the total pore volume is increased. Furthermore, the required activation time for producing the activated carbon is significantly reduced—according to Table 1, from 800 minutes to 280 minutes.

### Example 2

Similarly to Example 1, Example 2 compares the activation of a carbon source in a rotary kiln heated indirectly by jacket heating, and by pulsating combustion in a pulsating fluidized bed. The carbon source used was respectively 10 kg of an already sulfonated styrene-divinylbenzene copolymer which was carbonized under inert atmosphere at a maximum temperature of 920° C. The carbon source was introduced into the reaction chamber and heated under inert atmosphere to the activation temperature of 920° C. The preheated process gas (N₂:H₂O:CO₂ at 30:70:0) was subsequently passed from the combustion chamber into the reaction chamber. On attainment of a specific surface area of 1600 m²/g, determined by previously calibrated 1-point BET, activation was ended in each case by interrupting the flow of process gas and cooling the resultant activated carbon to below 180° C. by infeed of an inert gas. For the pulsating fluidized bed, a significantly reduced activation time was required, as is clear from Table 2 below.

The spherical activated carbon particles obtained were analyzed for the total pore volume and the micropore volume. The specific surface area and the total pore volume were ascertained according to DIN ISO 9277:2014 by prior recording of a low-temperature nitrogen sorption isotherm. The micropore volume was determined in each case by the methodology of Dubinin-Radushkevich and also by t-plot. In addition, density functional theory (DFT) was used to ascertain the pore size distribution. The calculation model used was a DFT kernel for N₂/77 K on a carbon surface with assumption of slit pore geometry (“N₂ at 77 K on carbon (slit pore, QSDFT, equilibrium model”)). The methodology used is part of the kernel stored in the analysis software. The nitrogen sorption isotherms were determined using the AUTOSORB-IQ volumetric sorption instrument from Quantachrome GmbH & Co. KG. The results of the texture parameters derivable from the nitrogen isotherms are collated in Table 2.

TABLE 2
Texture parameters ascertained for activated carbon produced
by a pulsating fluidized bed and a rotary kiln

| | | Pulsating | |
|---|---|---|---|
| | | fluidized | Rotary |
| Texture parameter | Units | bed | kiln |
| Specific surface area | m²/g | 1612 | 1577 |
| (BET) | | | |
| Total pore volume | cm³/g | 0.8301 | 0.8203 |
| Micropore volume t-plot | cm³/g | 0.714 | 0.702 |
| Micropore volume DR | cm³/g | 0.722 | 0.714 |
| Activation time | min | 415 | 1000 |

It becomes clear that in a comparison between the process of the invention with pulsating fluidized bed and the process with a rotary kiln, the total pore volume is increased. Furthermore, the required activation time for producing the activated carbon is significantly reduced—according to Table 2, from 1000 minutes to 415 minutes.

### Example 3

Example 3 shows the effect of process gas composition on pore size distribution.

The carbon source used was respectively 10 kg of an already sulfonated styrene-divinylbenzene copolymer which was carbonized under inert atmosphere at a maximum temperature of 920° C. The carbon source was introduced into the reaction chamber and heated under inert atmosphere to the activation temperature of 957° C. The preheated process gas (N₂:H₂O:CO₂ at 30:70:0) was subsequently passed from the combustion chamber into the reaction chamber.

On attainment of a specific surface area of 1000 m²/g, determined by 1-point BET, activation was ended in each case by interrupting the flow of process gas and cooling the resultant glassy carbon to below 180° C. by infeed of an inert gas.

The use of carbon dioxide significantly increased the total pore volume for constant specific surface area, with the micropore volume remaining the same. It was therefore possible to increase the proportion of mesopores.

TABLE 3
Texture parameters ascertained for activated carbon
with different process gas compositions

| | | Pulsating | Pulsating |
|---|---|---|---|
| | | fluidized | fluidized |
| Texture parameter | Units | bed | bed |
| Process gas composition | N₂:H₂O:CO₂ [%] | 30:50:20 | 30:70:0 |
| Specific surface area (BET) | m²/g | 1060 | 1029 |
| Total pore volume | cm³/g | 0.715 | 0.472 |
| Micropore volume t-plot | cm³/g | 0.390 | 0.396 |
| Micropore volume DR | cm³/g | 0.469 | 0.419 |
| Activation time | min | 240 | 240 |

It is clear from the data in Table 3 that through the corresponding process gas composition which is to be set, the total pore volume can be altered; the micropore volume remains the same. It is possible accordingly, by varying the process gas composition, to increase the porosity in the other ranges, here in particular in the mesopore range between 2.8 nm and 4.4 nm, significantly. This pore formation in the mesopore range is achieved for the same activation time.

The invention allows the activated carbon quality, and here particularly the pore formation, to be adjusted correspondingly.

List of reference signs

| | |
|---|---|
| 1 | Process-technological plant |
| 2 | Combustion chamber |
| 3 | Reaction chamber |
| 4 | Calming zone |
| 5 | Reaction gas outlet |
| 6 | Fuel gas inlet |
| 7 | Mixing chamber |
| 8 | Combustion gas inlet |
| 9 | Inert gas inlet |
| 10 | Steam/water |
| 11 | Inlet for carbonized carbon source |
| 12 | Outlet for activated carbon |

1. A process for producing activated carbon, comprising:
providing a carbonized carbon source in a reaction chamber;
feeding a fuel gas and a combustion gas into a combustion chamber and burning the fuel gas and the combustion gas, to give a process gas;
fluidizing the carbonized carbon source in the reaction chamber in a fluidized bed to product a fluidized carbon source;
heating the fluidized carbon source;
introducing the process gas into the fluidized bed; and
activating the carbonized carbon source in the fluidized bed of the reaction chamber to give activated carbon.

2. The process for producing activated carbon as claimed in claim 1, further comprising the step of discharging the reaction gas from the reaction chamber.

3. The process for producing activated carbon as claimed in claim 1 wherein the fluidized bed is a pulsating fluidized bed.

4. The process for producing activated carbon as claimed in claim 3, wherein the pulsating fluidized bed is formed by pulsating combustion of the fuel gas for generating the process gas.

5. The process for producing activated carbon as claimed in claim 1 further comprising adding oxygen-free gas to the process gas prior to entry into the fluidized bed.

6. The process for producing activated carbon as claimed in claim 1 further comprising adding finely atomized water and/or steam to the process gas prior to entry into the fluidized bed.

7. The process for producing activated carbon as claimed in claim 1 wherein the process gas is introduced into the reaction chamber with the process gas being free of oxygen.

8. The process for producing activated carbon as claimed in claim 1, wherein a temperature of the process gas on entry into the reaction chamber is at least 650° C.

9. The process for producing activated carbon as claimed in claim 1 wherein the carbon source contains at least one polymer and/or at least one polymer-based compound.

10. The process for producing activated carbon as claimed in claim 1 wherein the carbon source is at least one composed of a particulate polymeric organic starting material.

11. The process for producing activated carbon as claimed in claim 1, wherein the carbon source is has been sulfonated prior to carbonization.

12. The process for producing activated carbon as claimed in claim 1 wherein the carbonized carbon source is heated in the reaction chamber to at least 650° C.

13. The process for producing activated carbon as claimed in claim 1 wherein the reactor for the activating step is a pulsation reactor.

14. An activated carbon obtained by a process as claimed in claim 1.

15. A method of using the activated carbon of claim 14 as one or more of an adsorbent, a filter, and a filter material.

16. The activated carbon of claim 14 wherein the activated carbon is in particulate form.

17. The activated carbon of claim 16 wherein the particulate form includes spherical particles.

18. A method of using the activated carbon of claim 15 by employing the activated carbon in waste water processing.

19. The process of producing activated carbon as claimed in claim 1 wherein the carbon source is a styrene-based polymer.
